(19) United States
(12) Patent Application Publication
(10) Pub. No.: US 2023/0305973 A1
(43) Pub. Date: Sep. 28, 2023

(54) MMI INTERFACE DEVICE AND COMPUTING SYSTEM BASED THEREON

(71) Applicant: Young-il Kim, Gyeonggi-Do (KR)

(72) Inventor: Young-il Kim, Gyeonggi-Do (KR)

(21) Appl. No.: 18/018,508

(22) PCT Filed: Jul. 30, 2020
(86) PCT No.: PCT/KR2020/010035

§ 371 Date: Jan. 27, 2023

(30) Foreign Application Priority Data
Jul. 30, 2020 (KR) 10-2020-0094885

(51) Int. Cl. G06F 13/16; G06F 13/24

(52) U.S. Cl. CPC G06F 13/1684; G06F 13/1657; G06F 13/24

(57) ABSTRACT

An MMI interface device and a computing system based thereon. An output MMI interface device is a device located between a master processor and a slave processor to exchange data between the master processor and the slave processor in an asynchronous manner, and includes a first memory bank that stores a large amount of data, a second memory bank that stores a large amount of data, and an RBM located between the first memory bank and the second memory bank and configured to determine a memory bank to be used by the master processor and a memory bank to be used by the slave processor, and connect a bus to each of the first memory bank and the second memory bank according to the determination so that the first memory bank and the second memory bank alternately output data from the master processor to the slave processor.

### TECHNICAL FIELD

The present invention relates to an interface device and a computing system based thereon, and more particularly to a memory medium interconnect (MMI) interface device interposed between a master processor and a slave processor to exchange data and output data from a master side to a slave side or from the slave side to the master side, and a computing system based thereon.

### BACKGROUND OF THE INVENTION

Today, with development of artificial intelligence, Internet of Things, etc., analysis and control of super-large volumes of data have been required, and accordingly, the need for parallel processing, functional distribution, and spatial integration has been increasing. As a result, a demand for manycore computing products has been increasing.

In a traditional master/slave memory architecture, a processor accesses a main system through a memory controller that provides critical control management for each memory transaction. In order to schedule the memory transaction, the memory controller manages a large amount of information about states of various components of the system, such as an address/command bus, a data bank, and a data bus, among other things. During each instance of memory reading, the memory controller issues a specific command to a memory module to micromanage all aspects of operations, such as row activation, column selection, bit line precharge, etc., which puts pressure on the address/command bus from a performance standpoint. In addition, the memory controller tracks a large number of states of potentially hundreds of independent memory banks to provide conflict-free access. At an appropriate time, for example, the memory controller may issue a maintenance command such as a DRAM refresh command. In a memory system having several different types, the memory controller may fulfill different maintenance requirements for different memory modules. In addition, the memory controller mediates between memory modules for data transfer on a shared memory bus.

Recently, a paradigm of a computer environment has been shifting to ubiquitous computing that allows a computer system to be used anytime and anywhere. As a result, the use of portable electronic devices such as mobile phones, digital cameras, and notebook computers has been rapidly increasing. Such a portable electronic device generally uses a memory system using a memory device, that is, a data storage device. The data storage device is used as a main storage device or an auxiliary storage device in the portable electronic device.

The data storage device using the memory device has advantages in that stability and durability are excellent since a mechanical driving unit is not included, an information access speed is high, and power consumption is low. As an example of the memory system having such advantages, the data storage device includes a universal serial bus (USB) memory device, a memory card having various interfaces, a solid state drive (SSD), etc.

Meanwhile, Korean Patent Publication No. 10-2013-0136535 (Patent Document 1) discloses a method of operating a memory module for processing a memory access operation in relation to a memory interface. The method includes determining a fixed response time at least partially for total memory latency of the memory module, identifying an available time slot for receiving return data from the memory module through a data bus, creating a first slot reservation by reserving the available time slot, and issuing a read request for the memory module through the data bus.

Patent Document 1 described above has a problem in that application to an asynchronous memory operation or system is difficult since an operating method of the memory module is basically based on a synchronous method.

### SUMMARY OF THE INVENTION

The present invention has been made in view of the above problems comprehensively, and it is an object of the present invention to provide an MMI interface device interposed between a master processor and a slave processor to exchange data and output data from a master side to a slave side or from the slave side to the master side, and a computing system based thereon.

It is another object of the present invention to provide a computing system based on an MMI interface device and an MMR network capable of overcoming system performance degradation due to a scheduling function of a single core of a computing system based on the MMI interface device, and improving system performance by applying memory medium ring (MMR) communication unified using networking technology and allowed to perform parallel processing.

To achieve the above object, an output memory medium interconnect (MMI) interface device according to a first embodiment of the present invention is
a device located between a master processor and a slave processor to exchange data between the master processor and the slave processor in an asynchronous manner, and includes
a first memory bank configured to store a large amount of data,
a second memory bank configured to store a large amount of data, and
a rotation bus master (RBM) located between the first memory bank and the second memory bank and configured to determine a memory bank to be used by the master processor and a memory bank to be used by the slave processor, and to connect a bus to each of the first memory bank and the second memory bank according to the determination so that the first memory bank and the second memory bank alternately output data from the master processor to the slave processor.

The output MMI interface device may support at least one of 1:1, 1:N, N:1, or N:N communication.

Each of the master processor and the slave processor connected to the output MMI interface device may include handshaking pins of initialization (Init), ready (Ready), and start (Start).

The RBM may include a first D flip-flop configured to receive a signal from the ready pin of the master processor and output a corresponding signal, a second D flip-flop configured to receive a signal from the ready pin of the slave processor and output a corresponding signal, a first AND gate configured to receive an output signal from each of the first D flip-flop and the second D flip-flop and output a logical product operation result, a second AND gate configured to receive an inverted output signal from each of the first D flip-flop and the second D flip-flop and output a logical product operation result, a third D flip-flop configured to receive an output signal from the first AND gate and output a corresponding signal, a fourth D flip-flop configured to receive an input of an output signal from the third D flip-flop and output an inverted signal of the input signal, a third AND gate configured to receive each of an output signal from the third D flip-flop and an inverted output signal from the fourth D flip-flop, perform a logical product operation, and provide an operation result output signal to the start pin of each of the master processor and the slave processor as an input signal, and a JK flip-flop configured to provide, as an input signal, an Init signal to the Init pin of each of the master processor and the slave processor, receive an output signal from the second AND gate, and output a signal for rotating the buses connected to the first memory bank and the second memory bank.

When all signals are output as “0” from the ready pins of the master and slave processors, the output MMI interface device may output “1” to the Init pins of the master and slave processors to report an initialization state, apply a “1” signal to the JK flip-flop to toggle a signal of an output pin of the JK flip-flop, and determine the buses connected to the first and second memory banks as a memory bank bus to be used by the master processor and a memory bank bus to be used by the slave processor, respectively.

When both the ready pins of the master and slave processors output “0” signals, the output MMI interface device may output a “1” signal to each of the Init pins of the master and slave processors to notify each processor that the RBM has been initialized, and apply a “1” signal to the JK flip-flop to toggle a signal of the output pin of the JK flip-flop and rotate the buses connected to the first and second memory banks.

To achieve the above object, an input MMI interface device according to a second embodiment of the present invention
is a device located between a master processor and a slave processor to exchange data between the master processor and the slave processor in an asynchronous manner, and includes
a first memory bank configured to store a large amount of data,
a second memory bank configured to store a large amount of data, and
an RBM located between the first memory bank and the second memory bank and configured to alternately use the first memory bank and the second memory bank so that the master processor receives data from the slave processor.

The input MMI interface device may support at least one of 1:1, 1:N, N:1, or N:N communication.

The master processor connected to the input MMI interface device may include handshaking pins of Init, ready, start, and interrupt (Intr), and the slave processor may include handshaking pins of Init, ready, and start.

The RBM may include a first D flip-flop configured to receive a signal from the ready pin of the master processor and output a corresponding signal, a second D flip-flop configured to receive a signal from the ready pin of the slave processor and output a corresponding signal, a first AND gate configured to receive an output signal from each of the first D flip-flop and the second D flip-flop and output a logical product operation result, a second AND gate configured to receive an inverted output signal from each of the first D flip-flop and the second D flip-flop and output a logical product operation result, a third D flip-flop configured to receive an output signal from the first AND gate and output a corresponding signal, a fourth D flip-flop configured to receive an input of an output signal from the third D flip-flop and output an inverted signal of the input signal, a third AND gate configured to receive each of an output signal from the third D flip-flop and an inverted output signal from the fourth D flip-flop, perform a logical product operation, and provide an operation result output signal to the start pin of each of the master processor and the slave processor as an input signal, and a JK flip-flop configured to provide, as an input signal, an Init signal to the Init pin of each of the master processor and the slave processor, receive an output signal from the second AND gate, and output a signal for rotating the buses connected to the first memory bank and the second memory bank.

When all signals are output as “0” from the ready pins of the master and slave processors, the input MMI interface device may output “1” to the Init pins of the master and slave processors to report an initialization state, apply a “1” signal to the JK flip-flop to toggle a signal of an output pin of the JK flip-flop, and determine the buses connected to the first and second memory banks as a memory bank bus to be used by the master processor and a memory bank bus to be used by the slave processor, respectively.

The input MMI interface device may be configured to connect the ready pin of the slave processor to the Intr pin of the master processor so that, when a “1” signal is output from the ready pin of the slave processor, the slave processor requests an interrupt service function of the master processor.

When both the ready pins of the master and slave processors output “0” signals, the input MMI interface device may output a “1” signal to each of the Init pins of the master and slave processors to notify each processor that the RBM has been initialized, and apply a “1” signal to the JK flip-flop to toggle a signal of the output pin of the JK flip-flop and rotate the buses connected to the first and second memory banks.

To achieve the above object, a computing system based on an MMI interface device according to the present invention includes
a core unit configured to perform a role and a function of a CPU in a computer system,
an MMI interface unit located between the core unit and an external input/output device unit to relay command signal transmission and data exchange between the core unit and the external input/output device unit, and
the external input/output device unit configured to receive a command and data from the core unit through the MMI interface unit to transmit the received command and data to an external device, and to receive a corresponding signal and data from an external device to transmit the received corresponding signal and data to the core unit through the MMI interface device.

The MMI interface device may be configured to have a structure in which an input MMI interface device and an output MMI interface device are connected in parallel, and may be configured so that the input MMI interface device and the output MMI interface device simultaneously perform functions.

The external input/output device unit may include an input functional unit configured to receive data from outside and transfer the data to the MMI interface device, an output functional unit configured to receive a command and data from the core unit through the MMI interface device and transmit the command and data to an external device, and an input/output controller configured to control input/output of data by the input functional unit and the output functional unit.

The input MMI interface device may be connected to the input functional unit of the external input/output device unit, and the output MMI interface device may be connected to the output functional unit of the external input/output device unit.

The core unit may be configured to perform a function of a master processor of the MMI interface device, and the input/output controller of the external input/output device unit may be configured to perform a function of a slave processor of the MMI interface device.

The MMI interface device may be configured to control an output speed of data according to a processing speed of the core unit functioning as the master processor, and to control an input speed of data according to a speed of the input/output controller functioning as the slave processor and an interrupt service processing speed of the master processor.

To achieve the above object, a computing system based on an MMI interface device and a memory medium ring (MMR) network includes
a core unit configured to perform a role and a function of a CPU in a computer system,
an MMI interface unit located between the core unit and an external input/output device unit to relay command signal transmission and data exchange between the core unit and the external input/output device unit,
an MMR network unit located between the MMI interface device and the external input/output device unit to perform command signal transmission and data exchange between the core unit and the external input/output device unit through an MMR network, and
the external input/output device unit configured to receive a command and data from the core unit through the MMR interface unit to transmit the received command and data to an external device, and to receive an output signal and data from an external device to transmit the received output signal and data to the core unit through the MMR network unit and the MMI interface device.

The MMI interface device may be configured to have a structure in which an input MMI interface device and an output MMI interface device are connected in parallel, and may be configured so that the input MMI interface device and the output MMI interface device simultaneously perform functions.

The input MMI interface device may be connected to an input functional unit of a message passing module (MPM) in an MMR network module of the MMR network unit, and the output MMI interface device may be connected to an output functional unit of the MPM.

The core unit and a controller (for example, an MCU, an MPU, an IoT controller, etc.) of the external input/output device unit may be configured to perform a master processor function of the MMI interface device, and a message passing controller (MPC) of the MPM in the MMR network module may be configured to perform a slave processor function of the MMI interface device.

A rotation bus interface memory (RBIM) in the MMR network module may support at least one of dedicated channels according to special purpose attributes such as unidirectional, bidirectional, N-channel, and odd/even.

According to the present invention, there is an advantage in that a conventional bus structure is improved to eliminate the need for time division multiplexing of a signal, so that a data exchange processing speed is fast, and a structure may be simplified in terms of hardware.

In addition, a computing system based on an MMI interface device uses an MMI interface including a single computing port, and thus does not use a peripheral component interconnect express (PCIe) main bus and a direct memory access (DMA) function. In this way, system performance may be improved by eliminating time division multiplexing, which is a performance deterioration factor, in the existing bus interface.

In addition, a computing system based on an MMI interface device and an MMR network may improve system performance by applying MMR communication unified using networking technology and allowed to perform parallel processing.

### BRIEF DESCRIPTION OF THE DRAWINGS

FIG. 1 is a diagram schematically illustrating a configuration of an output MMI interface device according to a first embodiment of the present invention;

FIG. 2 is a diagram illustrating a structure of an RBM of the output MMI interface device according to the first embodiment of the present invention;

FIG. 3 is a flowchart illustrating an operation process of the RBM of the output MMI interface device according to the first embodiment of the present invention;

FIG. 4 is a diagram schematically illustrating a configuration of an input MMI interface device according to a second embodiment of the present invention;

FIG. 5 is a diagram illustrating a structure of an RBM of the input MMI interface device according to the second embodiment of the present invention;

FIG. 6 is a flowchart illustrating an operation process of the RBM of the input MMI interface device according to the second embodiment of the present invention;

FIG. 7 is a diagram illustrating a linkage structure of an MMI interface device and an input/output device employed in a computing system based on the MMI interface device according to the present invention;

FIG. 8 is a diagram illustrating a linkage computing system structure of the MMI interface device and a lower input/output device according to the present invention;

FIG. 9 is a diagram illustrating an MMI interface/MMR network linkage structure employed in a computing system based on the MMI interface device and an MMR network according to the present invention; and

FIG. 10 is a diagram illustrating a linkage computing system structure of the MMI interface/MMR network and a lower input/output device according to the present invention.

### DETAILED DESCRIPTION

Hereinafter, embodiments of the present invention will be described in detail with reference to the accompanying drawings.

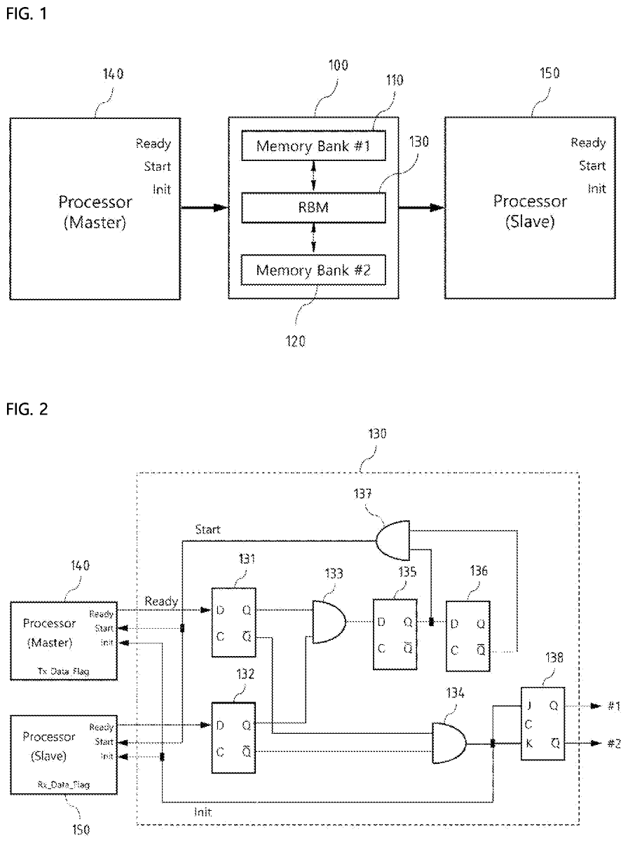

FIG. 1 is a diagram schematically illustrating a configuration of an output MMI interface device according to a first embodiment of the present invention.

Referring to FIG. 1, the output MMI interface device 100 according to the first embodiment of the present invention is a device located between a master processor 140 and a slave processor 150 to exchange data between the master processor 140 and the slave processor 150 in an asynchronous manner, and includes a first memory bank 110 for storing a large amount of data, a second memory bank 120 for storing a large amount of data, and a RBM 130 located between the first memory bank 110 and the second memory bank 120, determines a memory bank to be used by the master processor 140 and a memory bank to be used by the slave processor 150, and connects a bus to each of the first memory bank 110 and the second memory bank 120 according to the determination so that the first memory bank 110 and the second memory bank 120 alternately output data from the master processor 140 to the slave processor 150.

Here, the output MMI interface device 100 described above may support at least one of 1:1, 1:N, N:1, or N:N communication.

In addition, the master processor 140 and the slave processor 150 connected to the output MMI interface device 100 may each have handshaking pins of initialization (Init), ready (Ready), and start (Start).

In addition, as illustrated in FIG. 2, the RBM 130 of the output MMI interface device 100 may include a first D flip-flop 131 that receives a ready signal from the ready pin of the master processor 140 and outputs a corresponding signal, a second D flip-flop 132 that receives a ready signal from the ready pin of the slave processor 150 and outputs a corresponding signal, a first AND gate 133 that receives an output signal from each of the first D flip-flop 131 and the second D flip-flop 132 and outputs a logical product operation result, a second AND gate 134 that receives an inverted output signal from each of the first D flip-flop 131 and the second D flip-flop 132 and outputs a logical product operation result, a third D flip-flop 135 that receives an output signal from the first AND gate 133 and outputs a corresponding signal, a fourth D flip-flop 136 that receives an input of an output signal from the third D flip-flop 135 and outputs an inverted signal of the input signal, a third AND gate 137 that receives each of an output signal from the third D flip-flop 135 and an inverted output signal from the fourth D flip-flop 136, performs a logical product operation, and provides an operation result output signal to the start pin of each of the master processor 140 and the slave processor 150 as an input signal, and a JK flip-flop 138 that provides, as an input signal, an Init signal to the Init pin of each of the master processor 140 and the slave processor 150, receives an output signal from the second AND gate 134, and outputs a signal for rotating the buses connected to the first memory bank 110 (see FIG. 1) and the second memory bank 120.

In the output MMI interface device 100 according to the first embodiment of the present invention having the above configuration, when all signals (that is, ready signals) are output as “0” from the ready pins of the master and slave processors 140 and 150, the output MMI interface device 100 (more precisely, the RBM 130) may output “1” to the Init pins of the master and slave processors 140 and 150 to report an initialization state, apply a “1” signal to the JK flip-flop 138 to toggle a signal of an output pin of the JK flip-flop 138, and determine the buses connected to the first and second memory banks 110 and 120 as a memory bank bus to be used by the master processor 140 and a memory bank bus to be used by the slave processor 150, respectively.

In addition, each of the master and slave processors 140 and 150 outputs a signal for notifying the RBM 130 that each processor is ready to use the output MMI interface device 100 through each ready pin. In this instance, when a “1” signal indicating an initialized state is input from the RBM 130 to each of the Init pins of the master and slave processors 140 and 150, each of the master and slave processors 140 and 150 operates.

In addition, when the output MMI interface device 100 applies an Init signal to each of the Init pins of the master and slave processors 140 and 150, the master and slave processors 140 and 150 each output a “1” signal, which is an output signal for using the output MMI interface device 100, through each ready pin to report that both the master and slave processors 140 and 150 may use the output MMI interface device 100. Then, the output MMI interface device 100 applies a “1” signal, which is a start signal, to each of the start pins of the master and slave processors 140 and 150.

In addition, upon receiving a “1” signal through the start pin, the master processor 140 performs a current task to be output to the memory bank assigned thereto, and in response to completion of the task, the master processor 140 outputs a “0” signal through the ready pin.

In addition, upon receiving a “1” signal through the start pin, the slave processor 150 performs a current task obtained by the master processor 140 completing a task and outputting the task to the memory bank assigned to the slave processor 150 in a last rotation cycle. When the system is first initialized, there is no information transmitted by the master processor 140, and thus the slave processor 150 immediately outputs a “0” signal indicating task completion through the ready pin.

In addition, when both the ready pins of the master and slave processors 140 and 150 output “0” signals, the output MMI interface device 100 outputs a “1” signal to each of the Init pins of the master and slave processors 140 and 150 to notify each processor that the RBM 130 has been initialized, and applies a “1” signal to the JK flip-flop 138 to toggle a signal of the output pin of the JK flip-flop 138 and rotate the buses connected to the first and second memory banks 110 and 120.

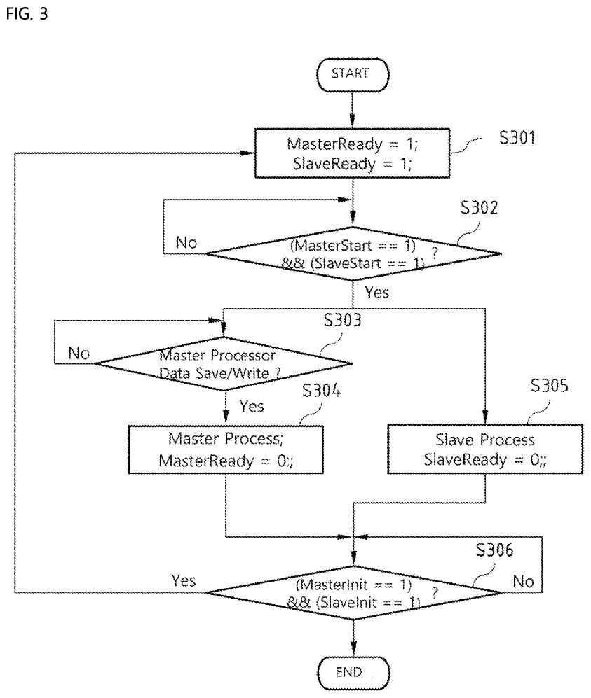

FIG. 3 is a flowchart illustrating an operation process of the RBM of the output MMI interface device according to the first embodiment of the present invention.

Referring to FIG. 3, first, when each of the ready pins of the master and slave processors 140 and 150 outputs a “1” signal (step S301) (which means that the RBM 130 is notified that both the master and slave processors 140 and 150 may use the output MMI interface device 100), the RBM 130 determines whether a “1” signal is input to each of the start pins of the master and slave processors 140 and 150 (step S302). In this determination, when the “1” signal is not input to each of the start pins of the master and slave processors 140 and 150, the RBM 130 continuously verifies whether the “1” signal is input, and when the “1” signal is input to each of the start pins of the master and slave processors 140 and 150, it is determined whether a data saving and/or writing function of the master processor 140 is executed (step S303). In this determination, when the data saving and/or writing function of the master processor 140 is not executed, the master processor 140 waits for execution of the data saving and/or writing function, and when the data saving and/or writing function of the master processor 140 is executed, the master processor 140 performs a current task to be output to the memory bank assigned thereto, and outputs a “0” signal through the ready pin in response to completion of the task (step S304).

In addition, upon receiving a “1” signal through the start pin of the slave processor 150 in the determination step S302, the slave processor 150 performs a current task obtained by the master processor 140 completing a task and outputting the task to the memory bank assigned to the slave processor 150 in a last rotation cycle as described above. Then, when the task is completed, a “0” signal is output through the ready pin (step S305).

Thereafter, the RBM 130 determines whether a “1” signal is input to each of the Init pins of the master processor 140 and the slave processor 150 (step S306), continuously verifies whether the “1” signal is input when the “1” signal is not input, and returns an operation program to the above step S301 when the “1” signal is input.

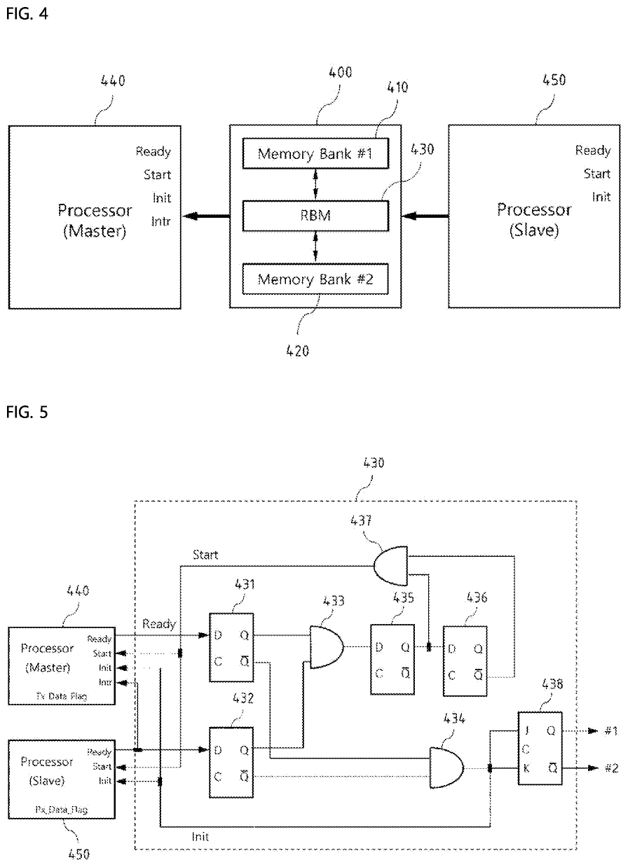

FIG. 4 is a diagram schematically illustrating a configuration of an input MMI interface device according to a second embodiment of the present invention.

Referring to FIG. 4, similarly to the output MMI interface device 100 described above, the input MMI interface device 400 according to the second embodiment of the present invention is a device located between a master processor 440 and a slave processor 450 to exchange data between the master processor 440 and the slave processor 450 in an asynchronous manner, and includes a first memory bank 410 for storing a large amount of data, a second memory bank 420 for storing a large amount of data, and a RBM 430 located between the first memory bank 410 and the second memory bank 420 to allow the master processor 440 to receive data from the slave processor 450 by alternately using the first memory bank 410 and the second memory bank 420.

The input MMI interface device 400 having the above configuration may support at least one of 1:1, 1:N, N:1, or N:N communication.

In addition, the master processor 440 connected to the input MMI interface device 410 may include handshaking pins of initialization (Init), ready (Ready), start (Start), and interrupt (Intr), and the slave processor 450 may include handshaking pins of initialization (Init), preparation (Ready), and start (Start).

In addition, the RBM 430 of the input MMI interface device 400 has the same basic configuration as that of the aforementioned RBM 130 of the output MMI interface device 100. However, the case where the input MMI interface device 400 is applied is different in that the Intr pin is further provided to the master processor 440, and an output signal from the ready pin of the slave processor 450 is input to the Intr pin of the master processor 440.

As illustrated in FIG. 5, the RBM 430 of the input MMI interface device 400 may include a first D flip-flop 431 that receives a signal from the ready pin of the master processor 440 and outputs a corresponding signal, a second D flip-flop 432 that receives a signal from the ready pin of the slave processor 450 and outputs a corresponding signal, a first AND gate 433 that receives an output signal from each of the first D flip-flop 431 and the second D flip-flop 432 and outputs a logical product operation result, a second AND gate 434 that receives an inverted output signal from each of the first D flip-flop 431 and the second D flip-flop 432 and outputs a logical product operation result, a third D flip-flop 435 that receives an output signal from the first AND gate 433 and outputs a corresponding signal, a fourth D flip-flop 436 that receives an input of an output signal from the third D flip-flop 435 and outputs an inverted signal of the input signal, a third AND gate 437 that receives each of an output signal from the third D flip-flop 435 and an inverted output signal from the fourth D flip-flop 436, performs a logical product operation, and provides an operation result output signal to the start pin of each of the master processor 440 and the slave processor 450 as an input signal, and a JK flip-flop 438 that provides, as an input signal, an Init signal to the Init pin of each of the master processor 440 and the slave processor 450, receives an output signal from the second AND gate 434, and outputs a signal for rotating buses connected to the first memory bank 410 and the second memory bank 420.

In the input MMI interface device 400 according to the second embodiment of the present invention having the above configuration, when all signals (that is, ready signals) are output as “0” from the ready pins of the master and slave processors 440 and 450, the input MMI interface device 400 (more precisely, the RBM 430 of the input MMI interface device 400) may output “1” to the Init pins of the master and slave processors 440 and 450 to report an initialization state, apply a “1” signal to the JK flip-flop 438 to toggle a signal of an output pin of the JK flip-flop 438, and determine buses connected to the first and second memory banks 410 and 420 as a memory bank bus to be used by the master processor 440 and a memory bank bus to be used by the slave processor 450, respectively.

In addition, the input MMI interface device 400 may be configured to connect the ready pin of the slave processor 450 to the Intr pin of the master processor 440 so that, when a “1” signal is output from the ready pin of the slave processor 450, the slave processor 450 requests an interrupt service function of the master processor 440.

In addition, in order to perform an interrupt service request of the slave processor 450, the master processor 440 outputs a “1” signal through the ready pin to inform the RBM 430 that the input MMI interface device 400 is ready for use. In this instance, when a “1” signal indicating an processing state is input from the RBM 430 to the start pin of the master processor 440, the master processor 440 operates.

In addition, when the input MMI interface device 400 applies an Init signal to each of the Init pins of the master and slave processors 440 and 450, the master and slave processors 440 and 450 each output a “1” signal, which is an output signal for using the input MMI interface device 400, through each ready pin to report that both the master and slave processors 440 and 450 may use the input MMI interface device 400. Then, the input MMI interface device 400 applies a “1” signal, which is a start signal, to each of the start pins of the master and slave processors 440 and 450.

In addition, upon receiving a “1” signal through the start pin, the slave processor 450 performs a current task to be output to the memory bank assigned thereto, and in response to completion of the task, the slave processor 450 outputs a “0” signal through the ready pin.

In addition, upon receiving a “1” signal through the start pin, the master processor 440 performs a current task obtained by the slave processor 450 completing a task and inputting the task to the memory bank assigned to the master processor 440 in the last rotation cycle. In this instance, when the system is first initialized, there is no information transmitted by the slave processor 450, and thus the master processor 440 immediately outputs a “0” signal indicating task completion through the ready pin.

In addition, when both the ready pins of the master and slave processors 440 and 450 output “0” signals, the input MMI interface device 400 outputs a “1” signal to each of the Init pins of the master and slave processors 440 and 450 to notify each processor that the RBM 430 has been initialized, and applies a “1” signal to the JK flip-flop 438 to toggle a signal of the output pin of the JK flip-flop 438 and rotate the buses connected to the first and second memory banks 410 and 420.

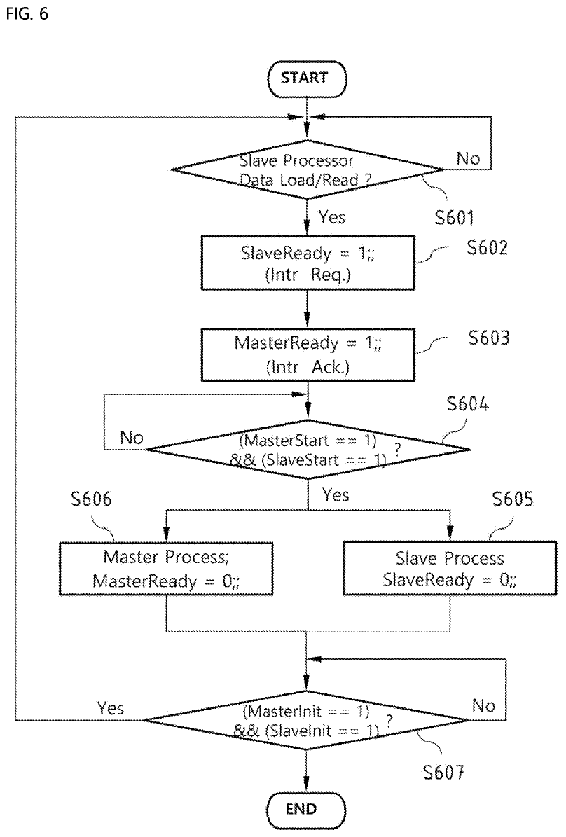

FIG. 6 is a flowchart illustrating an operation process of the RBM of the input MMI interface device according to the second embodiment of the present invention.

Referring to FIG. 6, the RBM 430 of the input MMI interface device 400 first determines whether a data loading and/or reading function of the slave processor 450 is executed (step S601), and waits for execution of the data loading and/or reading function when the data loading and/or reading function is not executed. When the data loading and/or reading function is executed in the determination, the slave processor 450 outputs a “1” signal to the ready pin to request an interrupt service function of the master processor 440 (step S602). Then, the master processor 440 outputs a “1” signal to the ready pin to report reception of the request for the interrupt service function (step S603).

Thereafter, the RBM 430 determines whether a “1” signal is input to each the start pins of the master and slave processors 440 and 450 (step S604), and continuously verifies whether the “1” signal is input when the “1” signal is not input. Further, in this determination, when a “1” signal is input to each of the start pins of the master and slave processors 440 and 450, the slave processor 450 performs a current task to be output to the memory bank assigned thereto, and outputs a “0” signal through the ready pin in response to completion of the task (step S605).

In addition, upon receiving a “1” signal through the start pin, the master processor 440 performs a current task obtained by the slave processor 450 completing a task and inputting the task to the memory bank assigned to the master processor 440 in the last rotation cycle. Further, when the task is completed, a “0” signal is output through the ready pin (step S606).

Thereafter, the RBM 430 determines whether a “1” signal is input to each of the Init pins of the master processor 440 and the slave processor 450 (step S607), continuously verifies whether the “1” signal is input when the “1” signal is not input, and returns an operation program to the above step S601 when the “1” signal is input.

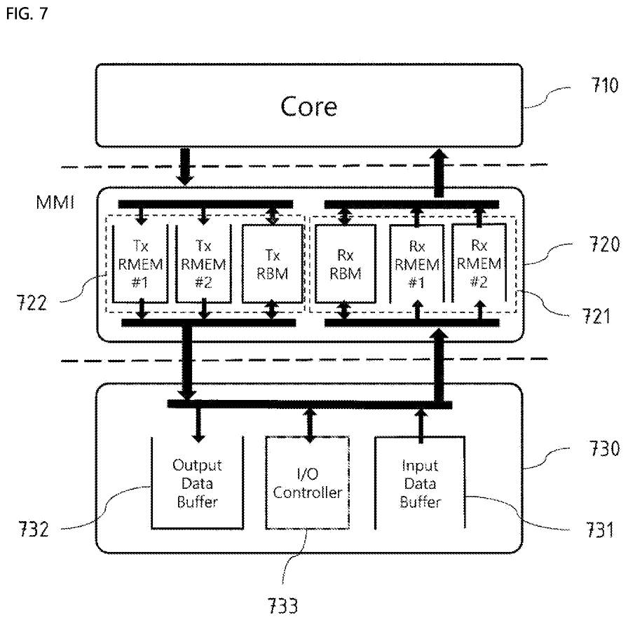

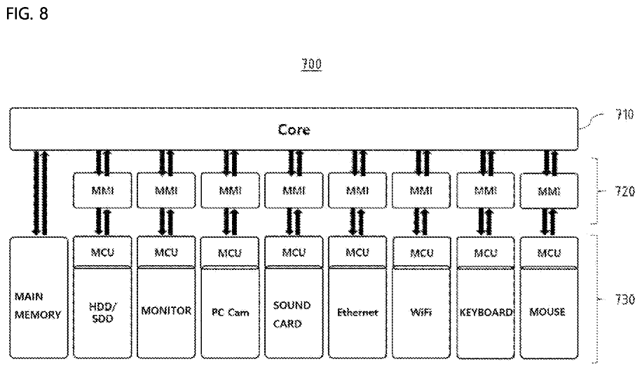

Meanwhile, FIGS. 7 and 8 illustrate a computing system based on the MMI interface device according to the present invention, FIG. 7 is a diagram illustrating a linkage structure of the MMI interface device and an input/output device, and FIG. 8 is a diagram illustrating a linkage computing system structure of the MMI interface device and a lower input/output device.

Referring to FIGS. 7 and 8, a computing system 700 based on the MMI interface device according to the present invention includes a core unit 710, an MMI interface unit 720, and an external input/output device unit 730.

The core unit 710 performs a role and a function of a CPU (or core) in the computer system.

The MMI interface device 720 is located between the core unit 710 and the external input/output device unit 730, and relays command signal transmission and data exchange between the core unit 710 and the external input/output device unit 730.

The external input/output device unit 730 receives a command and data from the core unit 710 through the MMI interface unit 720 to transmit the received command and data to an external device, and receives a corresponding signal (or input signal) and data from an external device to transmit the received corresponding signal (or input signal) and data to the core unit 710 through the MMI interface device 720.

Here, the MMI interface device 720 is configured to have a structure in which an input MMI interface device 721 and an output MMI interface device 722 are connected in parallel, and may be configured so that the input MMI interface device 721 and the output MMI interface device 722 simultaneously perform functions.

In addition, the external input/output device unit 730 may include an input functional unit 731 that receives data from the outside and transfers the data to the MMI interface device 720, an output functional unit 732 that receives a command and data from the core unit 710 through the MMI interface device 720 and transmits the command and data to an external device, and an input/output controller 733 that controls input/output of data by the input functional unit 731 and the output functional unit 732. In this instance, an MCU, an MPU, an IoT controller, etc. may be used as the input/output controller 733.

In this instance, the input MMI interface device 721 is connected to the input functional unit 731 of the external input/output device unit 730, and the output MMI interface device 722 is connected to the output functional unit 732 of the external input/output device unit 730.

In addition, the core unit 710 may be configured to perform a function of a master processor of the MMI interface device 720, and the input/output controller 733 of the external input/output device unit 730 may be configured to perform a function of a slave processor of the MMI interface device 720.

In addition, the MMI interface device 720 may be configured to control an output speed of data according to a processing speed of the core unit 710 functioning as the master processor, and to control an input speed of data according to a speed of the input/output controller 733 functioning as the slave processor and an interrupt service processing speed of the master processor.

The computing system 700 based on the MMI interface device having the above configuration uses an MMI interface including a single port, and thus does not use a PCIe main bus and a DMA function. In this way, system performance may be improved by eliminating time division multiplexing, which is a performance deterioration factor, in the existing bus interface.

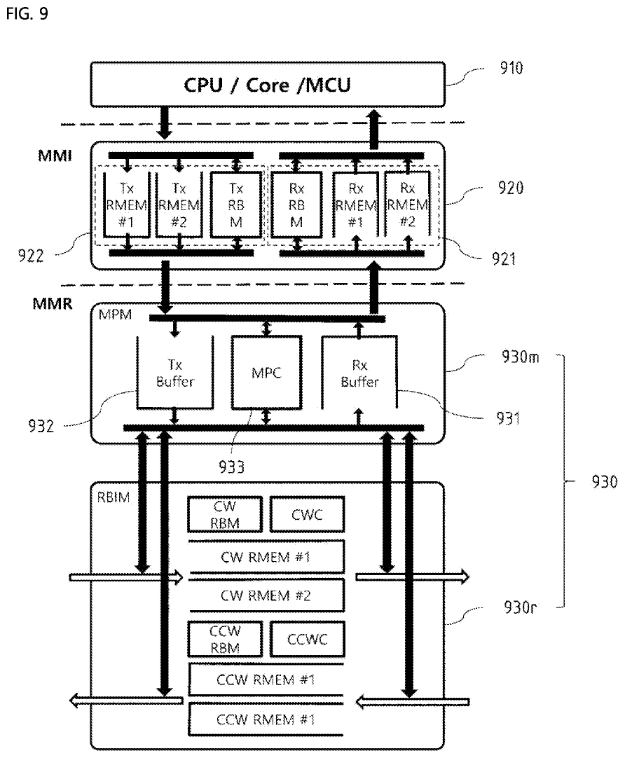

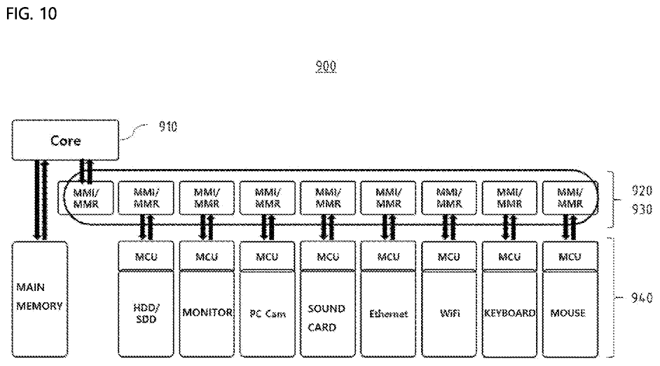

FIGS. 9 and 10 illustrate a computing system based on the MMI interface device and the MMR network according to the present invention, FIG. 9 is a diagram illustrating an MMI interface/MMR network linkage structure, and FIG. 10 is a diagram illustrating a linkage computing system structure of the MMI interface/MMR network and a lower input/output device.

Referring to FIGS. 9 and 10, the computing system 900 based on the MMI interface device and the MMR network according to the present invention is a linkage computing system of the MMI interface/MMR network and the lower input/output device, and is a computing system capable of obtaining performance improvement by overcoming a problem of performance degradation due to communication with a plurality of external input/output devices through time division multiplexing by a scheduling function of a single core, which is a characteristic appearing in a general bus structured computing system or a PCI/PCIe type computing system, which is a disadvantage of the above-mentioned linkage computing system structure of the MMI interface device and the lower input/output device described above, and by applying an advantage of MMR communication unified using networking technology and allowed to perform parallel processing.

The computing system 900 based on the MMI interface device and the MMR network includes a core unit 910, an MMI interface unit 920, an MMR network unit 930, and an external input/output device unit 940.

The core unit 910 performs a role and a function of a CPU in a computer system. The core unit 910 may include a CPU, a core, an MCU, an MPU, an IoT controller, etc.

The MMI interface device 920 is located between the core unit 910 and the external input/output device unit 940, and relays command signal transmission and data exchange between the core unit 910 and the external input/output device unit 940.

The MMR network unit 930 is located between the MMI interface device 920 and the external input/output device unit 940 to perform command signal transmission and data exchange between the core unit 910 and the external input/output device unit 940 through an MMR network. Here, the MMR network is specifically described in Korean Patent Application No. 10-2019-0154971 (multi-level network system having memory medium ring structure, and communication method, filed on Nov. 28, 2019) and Korean Patent Application No. 10-2019-0154972 (multi-channel network system using memory medium ring technology and data packet transmission method, filed on Nov. 28, 2019) filed by the same applicant as the present applicant, which will be referred to, and a detailed description thereof will be omitted here.

The external input/output device unit 940 receives a command and data from the core unit 910 through the MMR network unit 930 to deliver the received command and data to an external device, and receives an output signal and data from an external device to transmit the received output signal and data to the core unit 910 through the MMR network unit 930 and the MMI interface unit 920.

Here, the MMI interface device 920 is configured to have a structure in which an input MMI interface device 921 and an output MMI interface device 922 are connected in parallel, and may be configured so that the input MMI interface device 921 and the output MMI interface device 922 simultaneously perform functions.

In this instance, the input MMI interface device 921 may be connected to an input functional unit 931 of an MPM 930m in an MMR network module of the MMR network unit 930, and the output MMI interface device 922 may be connected to an output functional unit 932 of the MPM 930m.

In addition, the core unit 910 and a controller (for example, an MCU, an MPU, an IoT controller, etc.) of the external input/output device unit 940 may be configured to perform a master processor function of the MMI interface device 920, and an MPC 933 of the MPM 930m in the MMR network module may be configured to perform a slave processor function of the MMI interface device 920.

In addition, an RBIM 930r in the MMR network module may support at least one of dedicated channels according to special purpose attributes such as unidirectional, bidirectional, N-channel, and odd/even.

In addition, an HDD/SSD, which is a storage device of the external input/output device unit 940, and various external input/output devices such as a monitor, a webcam, a sound card, Ethernet, Wi-Fi, a keyboard, a mouse, etc. are connected to individual MMI interfaces/MMR networking modules.

As described above, the MMI interface device according to the present invention has an advantage in that a conventional bus structure is improved to eliminate the need for time division multiplexing of a signal, so that a data exchange processing speed is fast, and a structure may be simplified in terms of hardware.

In addition, the computing system based on the MMI interface device uses an MMI interface including a single computing port, and thus does not use a PCIe main bus and a DMA function. In this way, system performance may be improved by eliminating time division multiplexing, which is a performance deterioration factor, in the existing bus interface.

In addition, the computing system based on the MMI interface device and the MMR network may improve system performance by applying MMR communication unified using networking technology and allowed to perform parallel processing.

Even though the present invention has been described in detail through preferred embodiments, the present invention is not limited thereto, and it is obvious to those skilled in the art that various changes and applications may be made without departing from the technical spirit of the present invention. Therefore, the true scope of protection of the present invention should be construed by the following claims, and all technical ideas within the scope equivalent thereto should be construed as being included in the scope of the present invention.

1. An output memory medium interconnect (MMI) interface device located between a master processor and a slave processor to exchange data between the master processor and the slave processor in an asynchronous manner, the device comprising:
a first memory bank configured to store a large amount of data;
a second memory bank configured to store a large amount of data; and
a rotation bus master (RBM) located between the first memory bank and the second memory bank and configured to determine a memory bank to be used by the master processor and a memory bank to be used by the slave processor, and to connect a bus to each of the first memory bank and the second memory bank according to the determination so that the first memory bank and the second memory bank alternately output data from the master processor to the slave processor.

2. The output MMI interface device according to claim 1, wherein the output MMI interface device supports at least one of 1:1, 1:N, N:1, or N:N communication.

3. The output MMI interface device according to claim 1, wherein each of the master processor and the slave processor connected to the output MMI interface device includes handshaking pins of initialization (Init), ready (Ready), and start (Start).

4. The output MMI interface device according to claim 3, wherein the RBM includes a first D flip-flop configured to receive a signal from the ready pin of the master processor and output a corresponding signal, a second D flip-flop configured to receive a signal from the ready pin of the slave processor and output a corresponding signal, a first AND gate configured to receive an output signal from each of the first D flip-flop and the second D flip-flop and output a logical product operation result, a second AND gate configured to receive an inverted output signal from each of the first D flip-flop and the second D flip-flop and output a logical product operation result, a third D flip-flop configured to receive an output signal from the first AND gate and output a corresponding signal, a fourth D flip-flop configured to receive an input of an output signal from the third D flip-flop and output an inverted signal of the input signal, a third AND gate configured to receive each of an output signal from the third D flip-flop and an inverted output signal from the fourth D flip-flop, perform a logical product operation, and provide an operation result output signal to the start pin of each of the master processor and the slave processor as an input signal, and a JK flip-flop configured to provide, as an input signal, an Init signal to the Init pin of each of the master processor and the slave processor, receive an output signal from the second AND gate, and output a signal for rotating the buses connected to the first memory bank and the second memory bank.

5. The output MMI interface device according to claim 4, wherein, when all signals are output as “0” from the ready pins of the master and slave processors, the output MMI interface device outputs “1” to the Init pins of the master and slave processors to report an initialization state, applies a “1” signal to the JK flip-flop to toggle a signal of an output pin of the JK flip-flop, and determines the buses connected to the first and second memory banks as a memory bank bus to be used by the master processor and a memory bank bus to be used by the slave processor, respectively.

6. The output MMI interface device according to claim 4, wherein, when both the ready pins of the master and slave processors output “0” signals, the output MMI interface device outputs a “1” signal to each of the Init pins of the master and slave processors to notify each processor that the RBM has been initialized, and applies a “1” signal to the JK flip-flop to toggle a signal of the output pin of the JK flip-flop and rotate the buses connected to the first and second memory banks.

7. An input MMI interface device located between a master processor and a slave processor to exchange data between the master processor and the slave processor in an asynchronous manner, the device comprising:
a first memory bank configured to store a large amount of data;
a second memory bank configured to store a large amount of data; and
an RBM located between the first memory bank and the second memory bank and configured to alternately use the first memory bank and the second memory bank so that the master processor receives data from the slave processor.

8. The input MMI interface device according to claim 7, wherein the input MMI interface device supports at least one of 1:1, 1:N, N:1, or N:N communication.

9. The input MMI interface device according to claim 7, wherein the master processor connected to the input MMI interface device includes handshaking pins of Init, ready, start, and interrupt (Intr), and the slave processor includes handshaking pins of Init, ready, and start.

10. The input MMI interface device according to claim 9, wherein the RBM includes a first D flip-flop configured to receive a signal from the ready pin of the master processor and output a corresponding signal, a second D flip-flop configured to receive a signal from the ready pin of the slave processor and output a corresponding signal, a first AND gate configured to receive an output signal from each of the first D flip-flop and the second D flip-flop and output a logical product operation result, a second AND gate configured to receive an inverted output signal from each of the first D flip-flop and the second D flip-flop and output a logical product operation result, a third D flip-flop configured to receive an output signal from the first AND gate and output a corresponding signal, a fourth D flip-flop configured to receive an input of an output signal from the third D flip-flop and output an inverted signal of the input signal, a third AND gate configured to receive each of an output signal from the third D flip-flop and an inverted output signal from the fourth D flip-flop, perform a logical product operation, and provide an operation result output signal to the start pin of each of the master processor and the slave processor as an input signal, and a JK flip-flop configured to provide, as an input signal, an Init signal to the Init pin of each of the master processor and the slave processor, receive an output signal from the second AND gate, and output a signal for rotating the buses connected to the first memory bank and the second memory bank.

11. The input MMI interface device according to claim 10, wherein, when all signals are output as “0” from the ready pins of the master and slave processors, the input MMI interface device outputs “1” to the Init pins of the master and slave processors to report an initialization state, applies a “1” signal to the JK flip-flop to toggle a signal of an output pin of the JK flip-flop, and determines the buses connected to the first and second memory banks as a memory bank bus to be used by the master processor and a memory bank bus to be used by the slave processor, respectively.

12. The input MMI interface device according to claim 9, wherein the input MMI interface device is configured to connect the ready pin of the slave processor to the Intr pin of the master processor so that, when a “1” signal is output from the ready pin of the slave processor, the slave processor requests an interrupt service function of the master processor.

13. The input MMI interface device according to claim 10, wherein, when both the ready pins of the master and slave processors output “0” signals, the input MMI interface device outputs a “1” signal to each of the Init pins of the master and slave processors to notify each processor that the RBM has been initialized, and applies a “1” signal to the JK flip-flop to toggle a signal of the output pin of the JK flip-flop and rotate the buses connected to the first and second memory banks.

14. A computing system based on an MMI interface device, the computing system comprising:
a core unit configured to perform a role and a function of a CPU in a computer system;
an MMI interface unit located between the core unit and an external input/output device unit to relay command signal transmission and data exchange between the core unit and the external input/output device unit; and
the external input/output device unit configured to receive a command and data from the core unit through the MMI interface unit to transmit the received command and data to an external device, and to receive a corresponding signal and data from an external device to transmit the received corresponding signal and data to the core unit through the MMI interface device.

15. The computing system according to claim 14, wherein the MMI interface device is configured to have a structure in which an input MMI interface device and an output MMI interface device are connected in parallel, and is configured so that the input MMI interface device and the output MMI interface device simultaneously perform functions.

16. The computing system according to claim 14, wherein the external input/output device unit includes an input functional unit configured to receive data from outside and transfer the data to the MMI interface device, an output functional unit configured to receive a command and data from the core unit through the MMI interface device and transmit the command and data to an external device, and an input/output controller configured to control input/output of data by the input functional unit and the output functional unit.

17. The computing system according to claim 16, wherein the input MMI interface device is connected to the input functional unit of the external input/output device unit, and the output MMI interface device is connected to the output functional unit of the external input/output device unit.

18. The computing system according to claim 16, wherein the core unit is configured to perform a function of a master processor of the MMI interface device, and the input/output controller of the external input/output device unit is configured to perform a function of a slave processor of the MMI interface device.

19. The computing system according to claim 16, wherein the MMI interface device is configured to control an output speed of data according to a processing speed of the core unit functioning as the master processor, and to control an input speed of data according to a speed of the input/output controller functioning as the slave processor and an interrupt service processing speed of the master processor.

20. A computing system based on an MMI interface device and a memory medium ring (MMR) network, the computing system comprising:
a core unit configured to perform a role and a function of a CPU in a computer system;
an MMI interface unit located between the core unit and an external input/output device unit to relay command signal transmission and data exchange between the core unit and the external input/output device unit;
an MMR network unit located between the MMI interface device and the external input/output device unit to perform command signal transmission and data exchange between the core unit and the external input/output device unit through an MMR network; and
the external input/output device unit configured to receive a command and data from the core unit through the MMI interface unit to transmit the received command and data to an external device, and to receive an output signal and data from an external device to transmit the received output signal and data to the core unit through the MMR network unit and the MMI interface device.

21. The computing system according to claim 20, wherein the MMI interface device is configured to have a structure in which an input MMI interface device and an output MMI interface device are connected in parallel, and is configured so that the input MMI interface device and the output MMI interface device simultaneously perform functions.

22. The computing system according to claim 20, wherein the input MMI interface device is connected to an input functional unit of a message passing module (MPM) in an MMR network module of the MMR network unit, and the output MMI interface device is connected to an output functional unit of the MPM.

23. The computing system according to claim 22, wherein the core unit and a controller of the external input/output device unit are configured to perform a master processor function of the MMI interface device, and a message passing controller (MPC) of the MPM in the MMR network module is configured to perform a slave processor function of the MMI interface device.

24. The computing system according to claim 22, wherein a rotation bus interface memory (RBIM) in the MMR network module supports at least one of dedicated channels according to special purpose attributes such as unidirectional, bidirectional, N-channel, and odd/even.
